(19) United States
(12) Patent Application Publication
(10) Pub. No.: US 2017/0132274 A1
(43) Pub. Date: May 11, 2017

(54) DYNAMIC SIGNAL OPERATIONS FOR DATABASE MANIPULATION IN COMPLEX COMPUTING NETWORKS

(71) Applicant: Clark Nelson Riley, Chicago, IL (US)

(72) Inventor: Clark Nelson Riley, Chicago, IL (US)

(21) Appl. No.: 15/349,697

(22) Filed: Nov. 11, 2016

Related U.S. Application Data
(60) Provisional application No. 62/254,122, filed on Nov. 11, 2015.

(51) Int. Cl. G06F 17/30

(52) U.S. Cl. CPC G06F 17/30377; G06F 17/3087

(57) ABSTRACT

Systems, methods, apparatuses, devices, computer program products, computer-executable instructions, and/or applications are provided for receiving at least one of identification information and location information from a mobile device; accessing, using the at least one of the identification information and the location information, a database entry associated with the identification information; accessing, based on the database entry, a customized update mechanism for the database entry; providing, to the mobile device, the customized update mechanism for the database entry; receiving, via the customized update mechanism, an update signal for the database entry; and applying the update signal to the database entry.

### TECHNICAL FIELD

This disclosure is directed to database manipulation in complex computing networks, suitably assigned to Class 707 (Art Unit 2157).

### BACKGROUND

A need exists for improved data elements capable of associating structured data in ways that provide for organizing and accessing the structured data with greater efficiency. Conventional software applications structure data in various ways to facilitate retrieval, such as by leveraging associations that may exist between data elements. The challenge is to leverage the numerous mechanisms of data collection that are currently available, to selectively determine when to generate a newly defined data item (e.g. an “attribute”) that is capable of dynamically associating the collected data in a manner that accelerates retrieval, and to further determine, in the event that the relevant attribute has previously been generated, ways in which to associate newly collected data with the previously generated attribute. Therefore, it is desirable to provide a new technological solution.

### SUMMARY

Briefly, aspects of the present disclosure describe a system for generating and updating database attributes using a class request sensor and an element sensor for a purpose of transforming database information into associated database information based in part upon evaluating the signal inputs or the update signals to determine whether an attribute has been previously generated.

In some embodiments, a method is provided for generating and updating database attributes using a class request sensor and an element sensor for a purpose of transforming database information into associated database information based in part upon evaluating the signal inputs or the update signals to determine whether an attribute has been previously generated.

In some embodiments, a non-transitory computer readable medium is provided for generating and updating database attributes using a class request sensor and an element sensor for a purpose of transforming database information into associated database information based in part upon evaluating the signal inputs or the update signals to determine whether an attribute has been previously generated.

Additionally, aspects of the present disclosure describe a system for manipulating a database using dynamic signal operations in a complex computing network. In some embodiments, a method is provided for receiving at least one of identification information and location information from a mobile device and accessing, using at least one of the identification information and the location information, a database entry associated with the identification information, based in part upon evaluating at least one of the identification information and the location information to determine a database entry exists in the database.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other objects and features will be in part apparent and in part pointed out hereinafter.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 is a block diagram illustrating a system environment for generating and updating database attributes using a class request sensor and an element sensor for a purpose of transforming database information into associated database information based in part upon evaluating the signal inputs or the update signals to determine whether an attribute has been previously generated, in accordance with some embodiments of the disclosure;

FIG. 2 shows aspects of a system environment for generating and updating database attributes using a class request sensor and an element sensor in greater detail, in accordance with some embodiments of the disclosure;

FIG. 3 shows a block diagram depicting functional aspects of a computing system in accordance with some embodiments of the present disclosure;

FIG. 4 shows a block diagram depicting additional functional aspects of a computing system in accordance with some embodiments of the present disclosure;

FIG. 5 is a diagram depicting a computerized method for generating and updating database attributes using a class request sensor and an element sensor for a purpose of transforming database information into associated database information based in part upon evaluating the signal inputs or the update signals to determine whether an attribute has been previously generated, in accordance with some embodiments of the disclosure.

Although similar reference numbers may be used to refer to similar elements for convenience, it can be appreciated that each of the various example implementations may be considered distinct variations.

### DETAILED DESCRIPTION

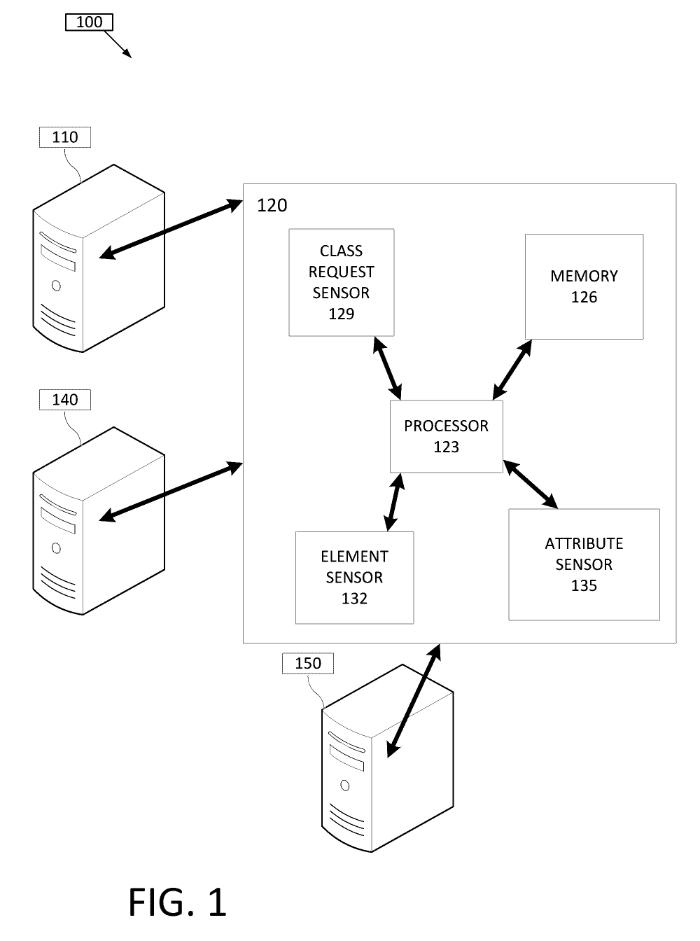

FIG. 1 is a block diagram illustrating a system environment 100 for generating and updating database attributes using an element sensor and an attribute sensor for a purpose of transforming signal inputs into associated database information based in part upon evaluating the signal inputs or the update signals to determine whether an attribute has been previously generated. The computing system 120 comprises a signal input communication interface for communicating with a signal input system 110, an update signal communication interface for communicating with an update signal system 140, and a signal output communication interface for communicating with a signal output system 150. In some embodiments, the signal input communication interface, the update signal communication interface, and the signal output communication interface may either be separate interfaces or the same interface. In some embodiments, the signal input system 110, the update signal system 140, and the signal output system 150 may either be separate systems or are the same system.

The computing system 120 may comprise a processor 123, a memory 126, and an input/output module (e.g., for inputting data into the computing system 123 and outputting data from the computing system 123). In some embodiments, the computing device 123 may comprise a class request sensor 129, an element sensor 132, and an attribute sensor 135. Any of the sensors described herein may be specialized sensors or non-specialized sensors. In some embodiments, a sensor may be a rules-based sensor that uses rules to determine when to submit requests to a server application, as will be described herein. Additionally or alternatively, a sensor may use rules to determine which requests to submit to the server application and/or which, if any, special processing instructions to include with the request. In some embodiments, one or more of these sensors may be located in the processor 123 and/or the memory 126. The memory 126 may comprise instructions or rules. In other embodiments, the class request sensor 129, the element sensor 132, and the attribute sensor 135 may be located outside the memory 126 or the processor 123. In still other embodiments, the class request sensor 129, the element sensor 132, and the attribute sensor 135 may be located outside the computing system 120. In some embodiments, the class request sensor 129, the element sensor 132, and the attribute sensor 135 may comprise a single sensor. The sensors may either be hardware sensors or software sensors. It is to be understood that any computing system described herein can operate as software executing on a computer which may include one or more processors.

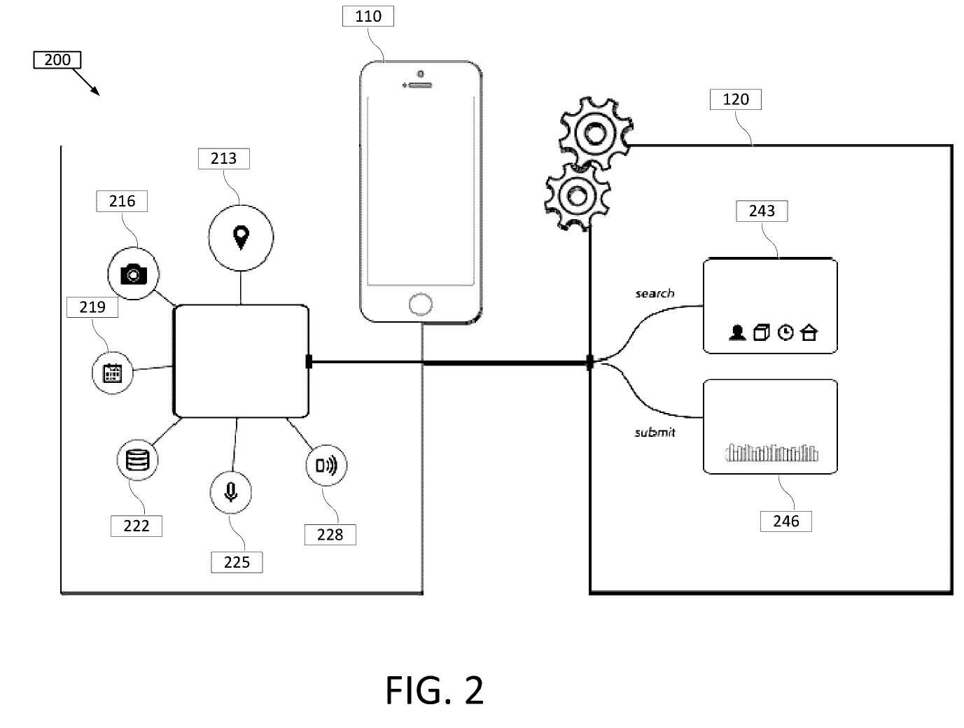

FIG. 2 shows aspects of a system environment 200 for generating and updating database attributes using an element sensor and an attribute sensor in greater detail, in accordance with some embodiments of the disclosure (e.g., as described in FIG. 1). In some embodiments, the system 200 may comprise a mobile input device 210. In some embodiments the mobile input device 210 comprises the signal input system 110. Further, in some embodiments the mobile input device 210 may be capable of leveraging various types of data and input mechanisms including at least one of the following: data from keyboard and other user interface controls provided by the mobile input device 210; location services 213 (based on GPS data, Wi-Fi data, current/historical location data, and/or interactive map input data); image capture mechanisms 216 for capturing data from mobile device cameras; personal management services 219 (based on calendar data, contact list data, phone log data, and/or email data); stored input data 222 specific to the signal input system 210 (such as web search history and web browser history); input data from the mobile device microphone input mechanisms 225; and various wireless communication mechanisms 228 (such as Wi-Fi, Bluetooth, wireless optical communication such as infrared communication, near field communication (NFC), and/or radio-frequency identification (RFID)).

With further reference to FIG. 2, in some embodiments, the system 200 may comprise a computing system 120 connected to the mobile input device 210 by at least one communication interface, as described herein. In some embodiments, an signal input received from the mobile input device 210 allows the system 200 to provide for a search of a class grouping repository 243, in part based upon determinations using the attribute sensor 135, as further described herein. In some embodiments, an update signal received from the mobile input device 210 allows the system 200 to provide a grouping to an element grouping repository 246, as further described herein.

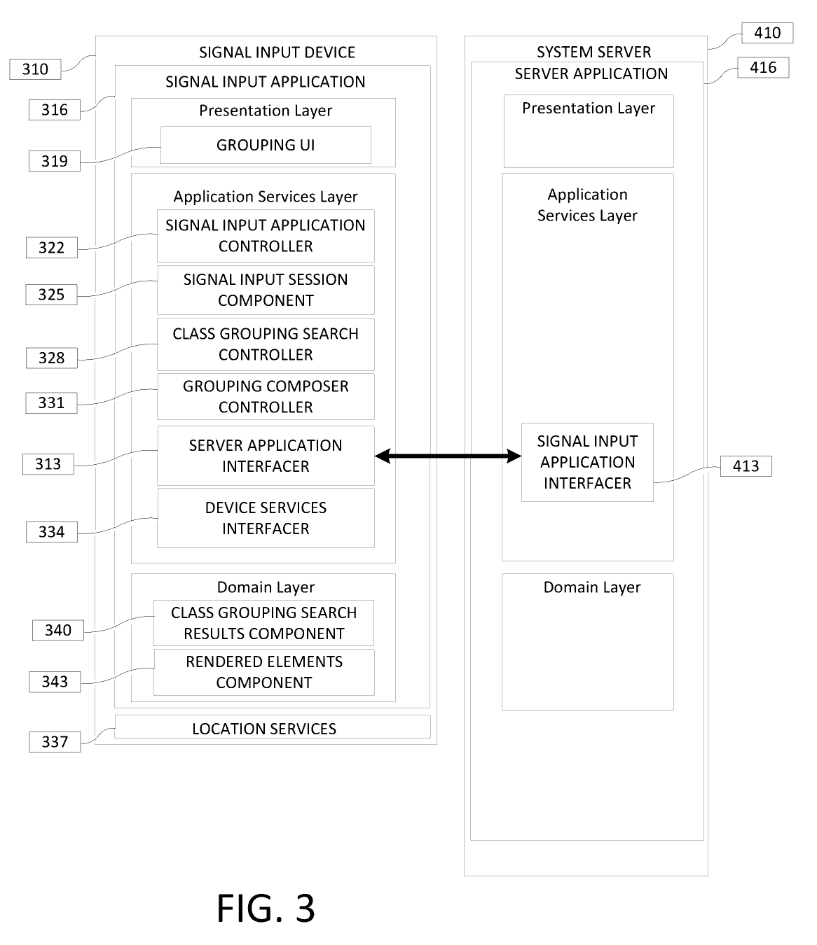

FIG. 3 shows a block diagram depicting functional aspects of a computing system in accordance with some embodiments of the present disclosure. As shown by FIG. 3, a server application interfacer 313 at the application services layer of the signal input device 310 may be communicatively connected to various components of a system server 410, which is described in greater detail herein. More specifically, in some embodiments, the server application interfacer 313 at the application services layer of the signal input device 310 may be communicatively connected to the signal input application interfacer 413 at the application services layer of the system server 410. In some embodiments, the server application interfacer 313 facilitates interactions between the signal input application 316 and the server application 416 by sending messages to and receiving messages from the signal input application interfacer 413 of the system server 410.

In some embodiments, the signal input device 310 may be a mobile input device 210 and/or a signal input system 110. Any units and/or subunits described herein with reference to the input system 110, the computing system 120, the update signal system 130 the output system 150, and/or the mobile input device 210 of FIGS. 1 and 2 may be included in one or more elements of FIG. 3 such as the processor 123, the memory 126, the class request sensor 129, the element sensor 132, and/or the attribute sensor 135.

The signal input device may include, among other elements, a signal input application 316 configured to receive and/or provide a request to create an element grouping to the computing system 120. In some embodiments, the signal input application 316 further comprises various components including a grouping UI 319 at the presentation layer of the signal input application 316, which provides a user interface for submitting the request to create an element grouping.

In some embodiments, the signal input application 316 further comprises various components at the application services layer, including a signal input application controller 322, which coordinates the overall operation of the signal input application 316; a signal input session component 325, which maintains data about the current user session in the form of a unique session identifier shared by objects associated with the signal input device 310 and/or the system server 410; a class grouping search controller 328, which coordinates the user interface interactions and application processes associated with finding and selecting a class grouping; and a grouping composer controller 331, which coordinates the user interface interactions and application processes associated with populating and submitting an element grouping. In some embodiments, the application layer further comprises a device services interfacer 334, which facilitates interactions between (a) the signal input application 316 and (b) services available on the signal input device 310 that are external to the signal input application 316, including the device's location services 337.

In some embodiments, the signal input application 316 further comprises various components at the domain layer, including a class grouping search results component 340, typically including more than one kind of information, such as locations, class grouping branches, class groupings, and/or other kinds of information that may be helpful in the process of finding and selecting a class grouping. Also, the domain layer of the signal input application 316 may comprise a rendered elements component 343, which manages the set of responses provided by a user that are specific to the elements of an element grouping.

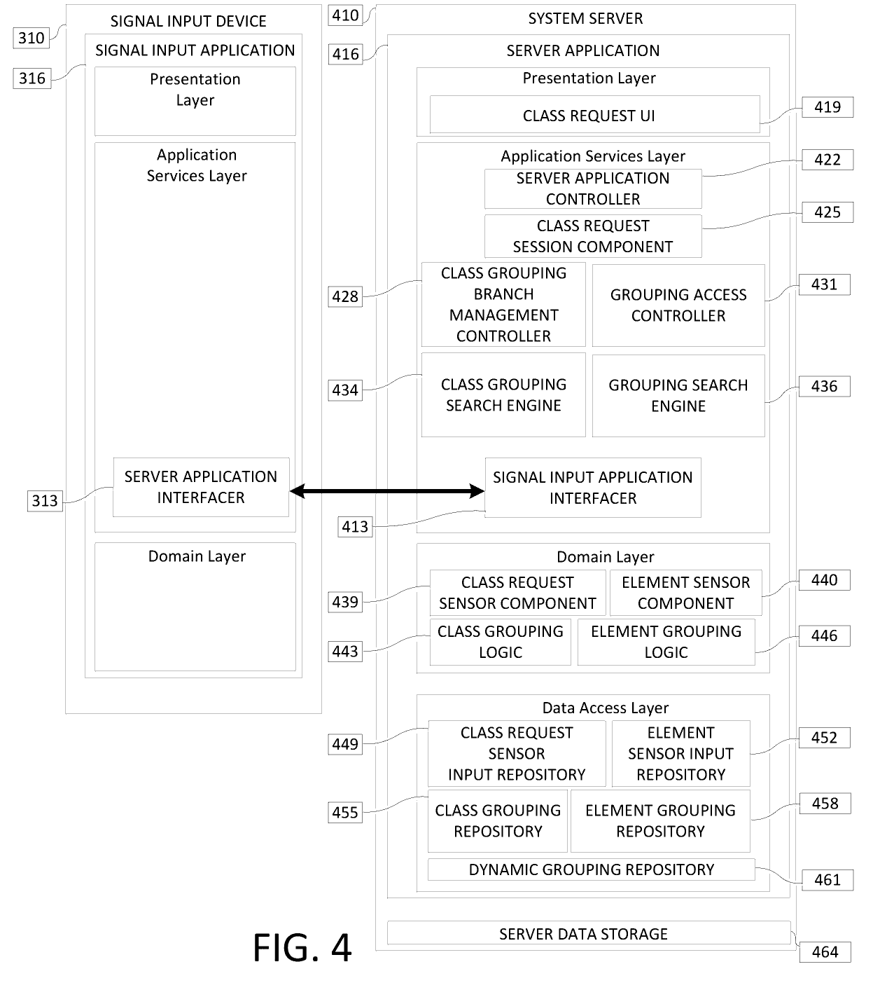

FIG. 4 shows a block diagram depicting additional functional aspects of a computing system in accordance with some embodiments of the present disclosure. As shown by FIG. 4 and described previously with reference to FIG. 3, a server application interfacer 313 at the application services layer of the signal input device 310 may be communicatively connected to various components of the system server 410 described in greater detail herein. More specifically, in some embodiments, the server application interfacer 313 at the application services layer of the signal input device 310 may be communicatively connected to the signal input application interfacer 413 at the application services layer of the system server 410. In some embodiments, the signal input application interfacer 413 facilitates interactions between the signal input application 316 and the server application 416 by sending messages to and receiving messages from the server application interfacer 313 of the signal input device 310.

In some embodiments, the system server 410 may include, among other elements, a server application 416 configured to provide centralized services to the computing system 120. In some embodiments, providing centralized services to the computing system 120 may be fulfilled by any number of components running on system server 410, which itself may be spread across any number of physical servers. In some embodiments, the server application 416 further comprises various components including a class request UI 419 at the presentation layer of the server application 416, which provides a user interface for various functions related to the class request sensor, which is further described herein.

In some embodiments, the server application 416 further comprises various components at the application services layer, including a server application controller 422, which facilitates interactions between the signal input application 316 and the server application 416 by sending messages to and receiving messages from the signal input application interface 413 of the server application 416; a class request session component 425, which maintains class request sensor data relevant to the current user session; a class grouping branch management controller 428, which coordinates the user interface interactions and application processes associated with creating and managing class grouping branches; and a grouping access controller 431, which coordinates the user interface interactions and application processes associated with finding, presenting and manipulating selections of element groupings from the dynamic grouping repository.

Further, in some embodiments, the application services layer comprises a class grouping search engine 434, a component that performs searches of various repositories in the data access layer as will be further described herein, and may also perform searches of other related repositories of centralized data. In some embodiments, the application services layer further comprises a grouping search engine 436, a component that performs searches related to the element grouping repository, as will be further described herein.

In some embodiments, the server application 416 further comprises various components at the domain layer, including a class request sensor component 439, which is used in various determinations related to creating software objects such as class groupings; an element sensor component 440, which is used in various determinations related to creating software objects such as element groupings; class grouping logic 443, which provides for specifying the attributes and behaviors of class groupings; and element grouping logic 446, which provides for specifying the attributes and behaviors of element groupings.

In some embodiments, the server application 416 further comprises various components at the data access layer, including a class request sensor input repository 449, which maintains a centralized collection of data related to the class request sensor component 439, and collaborates with additional components of the system server 410 such as server data storage 464 to provide persistent storage of data related to the class request sensor component 439; an element sensor input repository 452, which maintains a centralized collection of data related to the element sensor component 440 and collaborates with additional components of the system server 410 such as server data storage 464 to provide persistent storage of data related to the element sensor component 440. In addition, in some embodiments, the data access layer of the server application 416 may comprise additional repositories, such as a class grouping repository 455, an element grouping repository 458, and a dynamic grouping repository, as three non-limiting examples. These repositories perform similar functions related to maintaining centralized data collections and providing persistent storage in the manner described above.

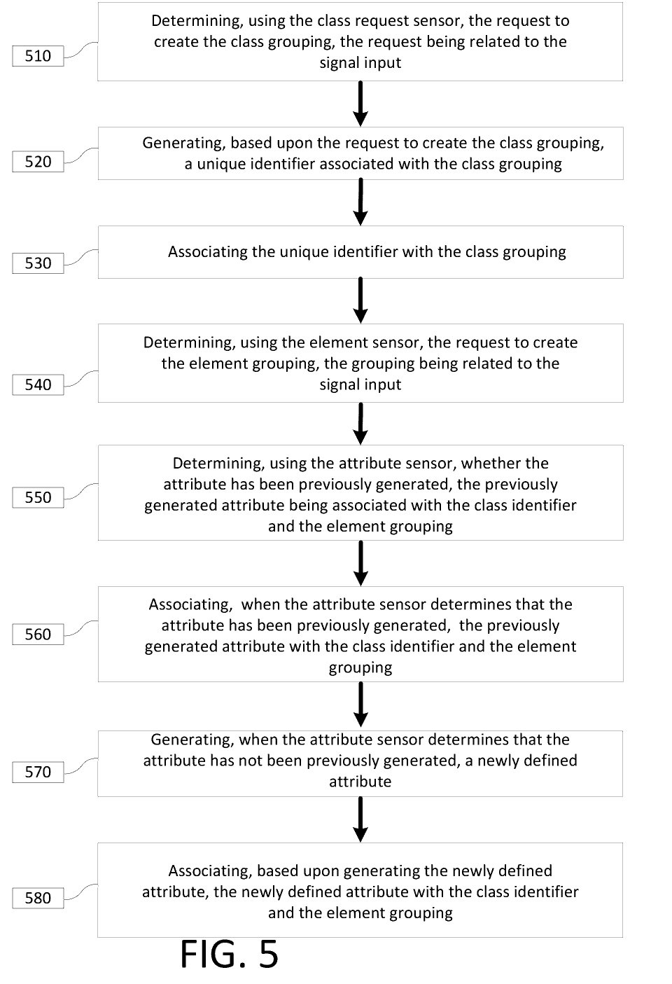

FIG. 5 is a diagram depicting a computerized method for generating and updating database attributes using a class request sensor and an element sensor for a purpose of transforming database information into associated database information based in part upon evaluating the signal inputs or the update signals to determine whether an attribute has been previously generated, in accordance with some embodiments of the disclosure. At block 510, the method comprises determining, using the class request sensor, the request to create the class grouping, the request being related to the signal input. At block 520, the method comprises generating, based upon the request to create the class grouping, a unique identifier associated with the class grouping. At block 530, the method comprises associating the unique identifier with the class grouping. At block 540, the method comprises determining, using the element sensor, the request to create the element grouping, the grouping being related to the signal input. At block 550, the method comprises determining, using the attribute sensor, whether the attribute has been previously generated, the previously generated attribute being associated with the class identifier and the element grouping. At block 560, the method comprises associating, when the attribute sensor determines that the attribute has been previously generated, the previously generated attribute with the class identifier and the element grouping. At block 570, the method comprises generating, when the attribute sensor determines that the attribute has not been previously generated, a newly defined attribute. At block 580, the method comprises associating, based upon generating the newly defined attribute, the newly defined attribute with the class identifier and the element grouping.

In some embodiments, a system is provided for generating and updating database attributes using a class request sensor and an element sensor for a purpose of transforming database information into associated database information based in part upon evaluating input signals or update signals to determine whether an attribute has been previously generated, wherein the generating and updating database attributes enables faster transforming of input signals into associated database information, the system comprising a data communication interface for: establishing a first connection to an input system; receiving, on the first connection, a signal input from the input system; establishing a second connection to a update system; receiving, on the second connection, an update signal from the update system, the update signal being associated with the signal input; a class request sensor for sensing a request to create a class grouping, the request being related to the signal input; an element sensor for sensing a request to create an element grouping, the grouping being associated with the signal input or the update signal; an attribute sensor for evaluating the signal input or the update signal to determine whether an attribute has been generated, the attribute being associated with the signal input or the update signal; a chipset and interfaced with a processor, the chipset having hardware for supporting the first connection to the input system, and the second connection to the update system; and the processor for: determining, using the class request sensor, the request to create the class grouping, the request being related to the signal input; generating, based upon the request to create the class grouping, a unique identifier related to the class grouping; associating the unique identifier with the class grouping; determining, using the element sensor, the request to create the element grouping, the element grouping being related to the signal input; determining, using the attribute sensor, whether the attribute has been previously generated, the previously generated attribute being associated with the class grouping, the class identifier, and the element grouping; associating, when the attribute sensor determines that the attribute has been previously generated, the attribute with the class grouping, the class identifier, and the element grouping; generating, when the attribute sensor determines that the attribute has not been previously generated, a newly defined attribute; and associating, based upon generating the newly defined attribute, the newly defined attribute with the class grouping, the class identifier, and the element grouping.

In some embodiments, a system is provided for manipulating a database using dynamic signal operations in a complex computing network. The system is configured for receiving at least one of identification information (e.g., associated with a subject such as an event, employee, product, service, business location, mobile device, etc.) and location information (e.g., associated with a subject such as an event, employee, product, service, business location, mobile device, etc.) from a mobile device, wherein the mobile device comprises a specialized sensor (e.g., a camera, a sensor to determine location or receive identification information, etc.) for sensing the at least one of the identification information and the location information; accessing, using the at least one of the identification information and the location information, a database entry (e.g., associated with a subject such as an event, employee, product, service, business location, mobile device, etc.) in the database; accessing, based on the database entry, a customized update mechanism (e.g., a customized input form) for the database entry; providing, to the mobile device, the customized update mechanism for the database entry; receiving, via the customized update mechanism, an update signal for the database entry; and applying the update signal to the database entry. The customized update mechanism refers to a specialized update mechanism (e.g., a specialized input form) for a particular data entry. Each data entry in the database may have a specialized update mechanism such that other data entries cannot be manipulated or updated using the specialized update mechanism. In some embodiments, the database may be a specialized database that is constructed to accommodate the customized update mechanism for each data entry.

The present application incorporates-by-reference the entirety of U.S. Provisional Application No. 62/254,122, filed Nov. 11, 2015, titled “Reviewer Application,” for all purposes.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range” of or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Lastly, although similar reference numbers may be used to refer to similar elements for convenience, it can be appreciated that each of the various example implementations may be considered distinct variations.

What is claimed is:

1. A system for manipulating a database using dynamic signal operations in a complex computing network, wherein each data entry in the database is manipulated using a customized update mechanism for a particular data entry, the system configured for:
receiving at least one of identification information and location information from a mobile device, wherein the mobile device comprises a sensor for sensing the at least one of the identification information and the location information;
determining, using the at least one of the identification information and the location information, whether a database entry exists in the database;
accessing, using the at least one of the identification information and the location information, the database entry in the database;
accessing, based on the database entry, a customized update mechanism for the database entry;
providing, to the mobile device, the customized update mechanism for the database entry;
receiving, via the customized update mechanism, an update signal for the database entry; and
applying the update signal to the database entry.
